(19) United States
(12) Patent Application Publication
(10) Pub. No.: US 2010/0286578 A1
(43) Pub. Date: Nov. 11, 2010

(54) Exerciser with massage function

(76) Inventor: Chin-Tsun Lee, Yungkang City (TW)

Correspondence Address: Dr. BANGER SHIA;Patent Office of Bang Shia, 102 Lindencrest Ct, Sugar Land, TX, 77479-5201, US

(21) Appl. No.: 12/436,666

(22) Filed: May 6, 2009

(51) Int. Cl. A61H 15/00; A63B 26/00

(52) U.S. Cl. 601/115; 482/142

(57) ABSTRACT

An exerciser includes a main frame having a support section. A seat is mounted on top of the support section and includes front and rear ends spaced in a first direction. Two handgrips are mounted on opposite sides of the seat and spaced in a second direction perpendicular to the first direction. A first roller mechanism includes a first roller support mounted to the support section and at least one first roller rotatably supported by the first roller support. A second roller mechanism includes a second roller support mounted to the support section and at least one second roller rotatably supported by the second roller support. The seat is intermediate the first and second roller supports in the first direction.

### BACKGROUND OF THE INVENTION

The present invention relates to an exerciser and, more particularly, to an exerciser allowing a user to move in either direction to obtain different massage effects.

A wide variety of exercisers has been proposed. U.S. Pat. No. 5,632,710 discloses an exercise apparatus including a frame on which a seat is mounted. A back support is mounted beneath the seat. The frame also supports a pivot arm whose movement is opposed by a resistance mechanism. A user can move the pivot arm to pivot relative to the frame while sitting on the seat and lying down on the back support. The resistance mechanism provides an exercising effect to the arms of the user. However, the back support does not provide massage function. Furthermore, the exercise apparatus allows use in a single direction for the user.

U.S. Pat. No. 7,125,366 discloses a sit up exercising apparatus including a main frame on which a seat and two handlebars are mounted. A back frame is pivotably mounted behind the seat. Rollers are mounted on opposite sides of the back frame. A user sitting on the seat can lie down on the rollers, causing the back frame to pivot downward so that the rollers can provide a massage effect. Elastic members mounted between the main frame and the back frame provide returning function for the back frame. However, only the back and the neck of the user can be massaged. Namely, the legs, waist, chest, and abdomen can not be massaged. Furthermore, the massage function can only be obtained when the user uses the exercising apparatus in a specific direction.

U.S. Pat. No. 6,312,401 discloses a collapsible cervical traction device including tubular primary support leg and a plurality of roller assemblies mounted on opposite sides of the support leg. A Y-shaped neck support assembly is provided and includes a tubular foam plastic cushion members to support the neck of the user. However, no massage function is provided at the back and the buttocks when the user lies down on the roller assemblies. Furthermore, the device can only be utilized in a single direction. Further, the device does not provide exercising function.

### BRIEF SUMMARY OF THE INVENTION

An objective of the present invention is to provide an exerciser that can provide massage effects regardless of the operating direction of the user.

Another objective of the present invention is to provide an exerciser that provides wider massage application.

An exerciser according to the preferred teachings of the present invention includes a main frame having a support section. A seat is mounted on top of the support section and includes front and rear ends spaced in a first direction. Two handgrips are mounted on opposite sides of the seat and spaced in a second direction perpendicular to the first direction. A first roller mechanism includes a first roller support mounted to the support section and at least one first roller rotatably supported by the first roller support. A second roller mechanism includes a second roller support mounted to the support section and at least one second roller rotatably supported by the second roller support. The seat is intermediate the first and second roller supports in the first direction.

In a preferred embodiment, the at least one first roller includes a plurality of soft rollers and a plurality of rigid rollers, and the rigid rollers and the soft rollers are alternately disposed.

In another preferred embodiment, the main frame further includes front and rear leg sections spaced in the first direction. The seat is intermediate the front and rear leg sections in the first direction. An axle extends through the front leg section and includes two ends on opposite sides of the front leg section. Two massage wheels are rotatably mounted on the two ends of the axle.

In a further preferred embodiment, the rear leg section includes at least one pin. Furthermore, a back frame is pivotably connected to the main frame and includes at least one peg. At least one elastic element includes a first end removably connected to the at least one pin and a second end removably connected to the at least one peg for biasing an end of the back frame upward and for returning the back frame. At least one third roller is rotatably mounted to the end of the back frame. One of the first and second ends of the at least one elastic element is removable from one of the at least one pin and the at least one peg, allowing the end of the back frame to be lowered.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows an exploded, perspective view of an exerciser of an embodiment according to the preferred teachings of the present invention.

FIG. 2 shows a perspective view of the exerciser of FIG. 1.

FIG. 3 is a side view of the exerciser of FIG. 1 showing a user lying on first and second roller mechanisms of the exerciser.

FIG. 4 is a side view of the exerciser of FIG. 1 showing a massage effect at the back of the user moving in a direction.

FIG. 5 is a side view of the exerciser of FIG. 1 showing a massage effect at the back of the user moving in an opposite direction.

FIG. 6 is a side view of the exerciser of FIG. 1 showing a massage effect at the front side of the user.

FIG. 7 is a side view of the exerciser of FIG. 1 showing a massage effect at the buttocks of the user.

FIG. 8 shows a modified example of the first roller mechanism of the exerciser according to the preferred teachings of the present invention.

FIG. 9 shows an elevational view of an exerciser utilizing the first roller mechanism of FIG. 8.

FIG. 10 shows a perspective view of an exerciser of another embodiment according to the preferred teachings of the present invention.

FIG. 11 shows a side view illustrating use of the exerciser of FIG. 10.

FIG. 12 shows a side view illustrating another user of the exerciser of FIG. 10.

FIG. 13 shows a perspective view of an exerciser of a further embodiment according to the preferred teachings of the present invention.

FIG. 14 shows a side view illustrating use of the exerciser of FIG. 13.

FIG. 15 shows a side view illustrating another use of the exerciser of FIG. 13.

FIG. 16 shows a side view illustrating a further use of the exerciser of FIG. 13.

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

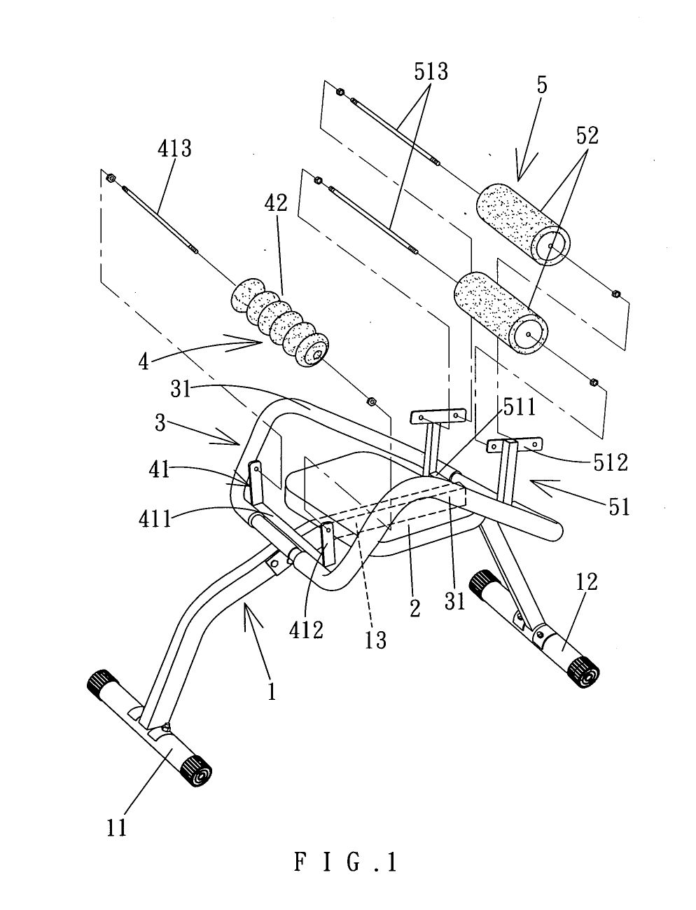

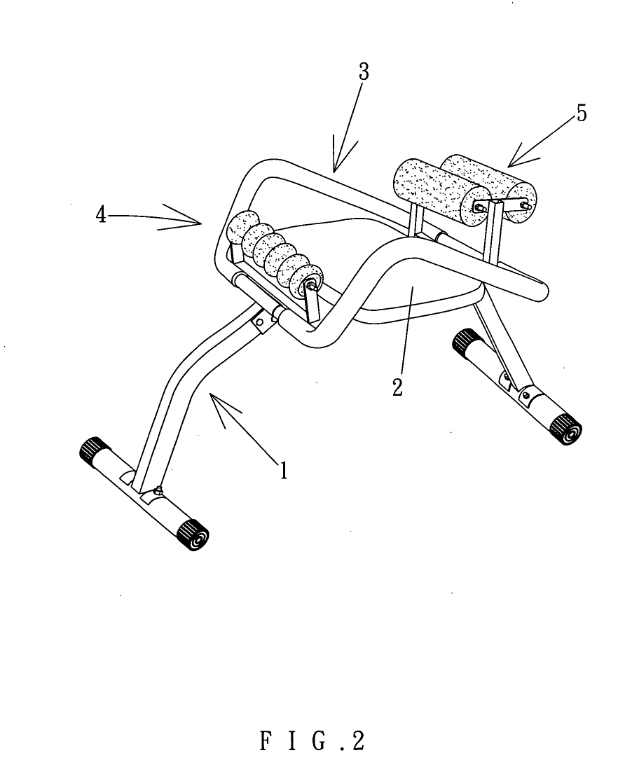

An exerciser of a first embodiment according to the preferred teachings of the present invention is shown in FIGS. 1-7. The exerciser includes a main frame 1 having front and rear leg sections 11 and 12 spaced in a first direction. The main frame 1 further includes a support section 13 intermediate the front and rear leg sections 11 and 12 in the first direction. The exerciser further includes a seat 2 mounted on top of the support section 13. The seat 2 includes front and rear ends spaced in the first direction. A handle device 3 is fixed to the main frame 1 with the seat 2 enclosed in the handle device 3. The handle device 3 includes two handgrips 31 on opposite sides of the seat 2 and spaced in a second direction perpendicular to the first direction.

The exerciser further includes a first roller mechanism 4 including a roller support 41 mounted to the support section 13 at a front side of the seat 2. At least one roller 42 is rotatably supported by the roller support 41. In this embodiment, the roller support 41 includes a coupling section 411 fixed to the support section 13 and two arms 412 extending upright from two ends of the coupling section 411. An axle 413 is extended through the arms 412. Six rollers 42 are rotatably mounted around the axle 413 between the arms 412. Each roller 42 is made of soft material such as foam plastic.

The exerciser further includes a second roller mechanism 5 including a roller support 51 mounted to the support section 13 at a rear side of the seat 2. At least one second roller 52 is rotatably supported by the roller support 51, and the seat 2 is intermediate the roller supports 41 and 51 in the first direction. In this embodiment, the roller support 51 includes a U-shaped coupling section 511 fixed to the support section 13 and first and second extensions 512 fixed to distal ends of two arms of the U-shaped coupling section 511. A first axle 513 is extended through an end of the first extension 512 and an end of the second extension 512. A second axle 513 parallel to the first axle 513 is extended through the other end of the first extension 512 and the other end of the second extension 512. A roller 52 is rotatably mounted around each of the first and second axles 513. Each roller 52 is made of soft material such as foam plastic.

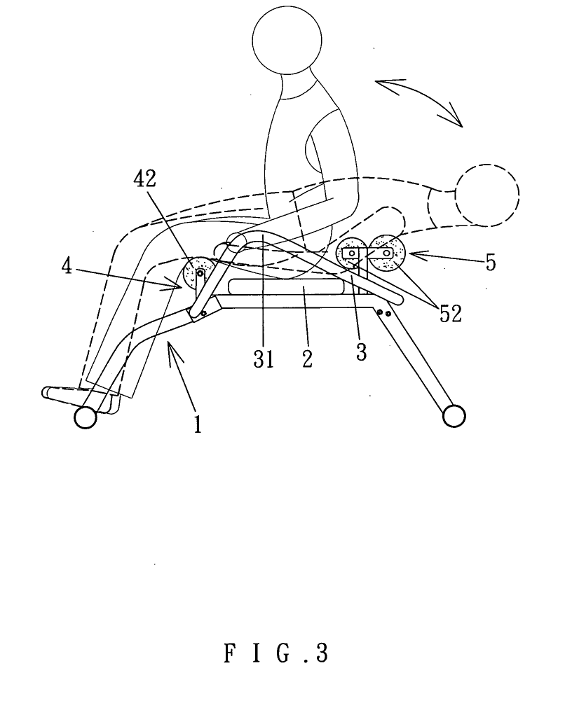

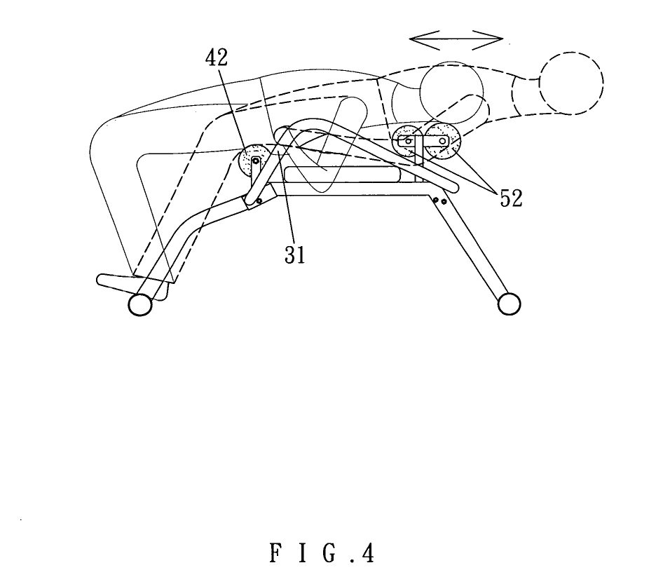

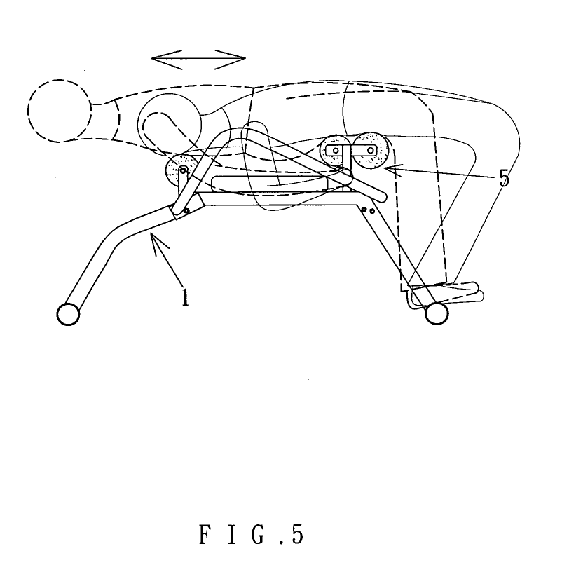

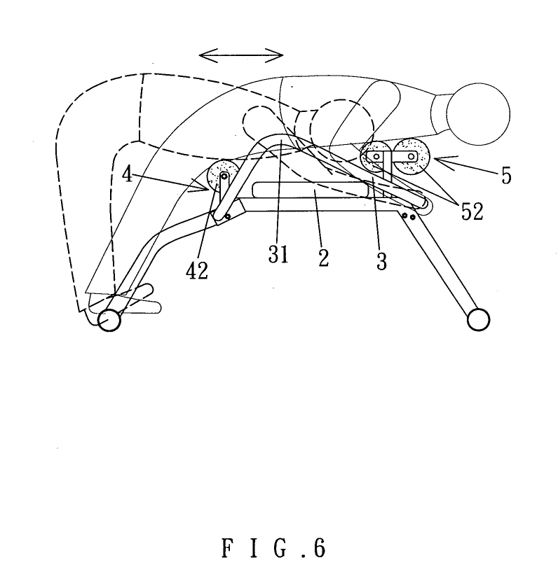

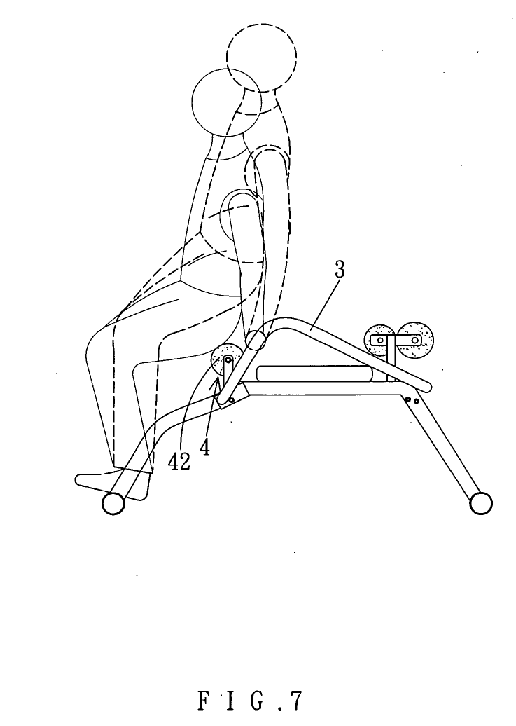

In use, a user can sit on the seat 2 in either direction so that the back of the user can lie on either the rollers 42 or the rollers 52. With reference to FIG. 3, the user can lie down with his or her back resting on the rollers 52 and with his or her thighs resting on the rollers 42. The user can move his or her body by stepping on the front leg section 11 or the ground to obtain a massage effect. With reference to FIG. 4, the user can grip the handgrips 31 and move his or her body to massage the rear side of the neck, back, waist, and legs by the rollers 42 and 52 while exercising his or her arms. With reference to FIG. 5, the user can lie down with his or her back resting on the rollers 42 and with his or her thighs resting on the rollers 52. Similarly, the user can move his or her body to massage the front side of the neck, back, waist, and legs by the rollers 42 and 52 while exercising his or her arms or legs. With reference to FIG. 6, the user can stand on the front leg section 11 facing the seat 2 and moves his or her body to rotate the rollers 42 and 52 so that the front side of his or her torso can be massaged while exercising his or her arms or legs. With reference to FIG. 7, the user can sit on the rollers 42 and grip the handle device 3 with his or her buttocks resting on the rollers 42. The buttocks can be massaged when the user moves against the rollers 42 while exercising the arms and legs. It can be appreciated that other portions of the user can be massaged using the rollers 42 and/or rollers 52.

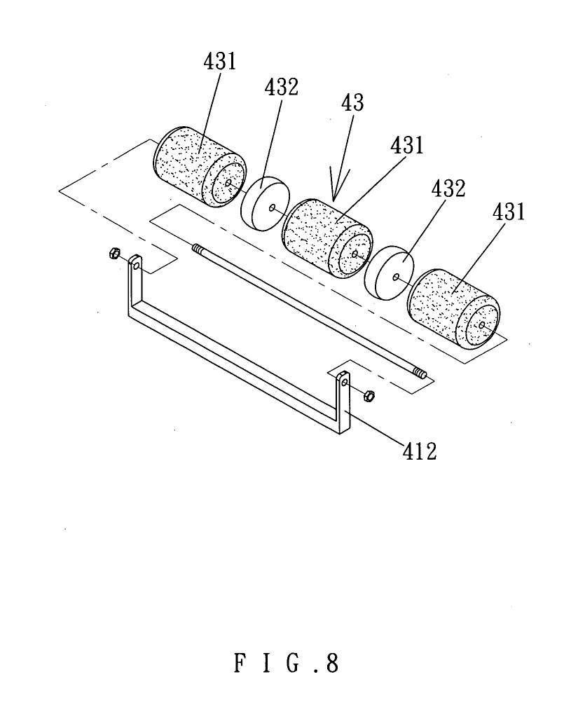

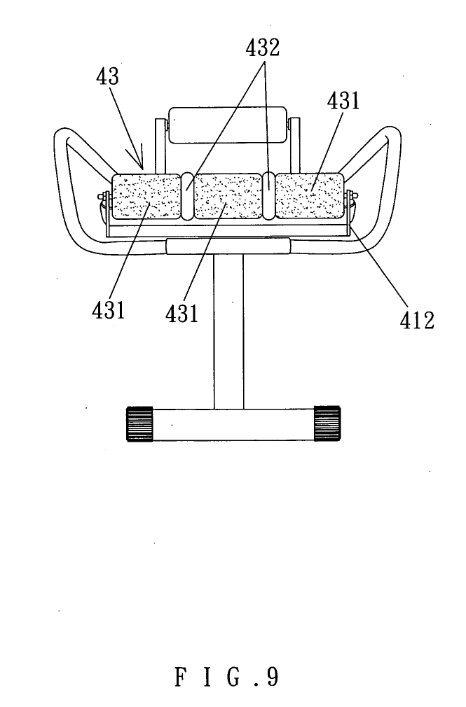

FIGS. 8 and 9 show a modified embodiment of the rollers. Specifically, the first roller mechanism 41 includes a roller unit 43 including a plurality of soft rollers 431 and a plurality of rigid rollers 432. The rigid roller 431 and the soft rollers 432 are alternately disposed. The soft rollers 431 can be made of foam plastic, and the rigid rollers 432 can be made of rigid plastic. When the body of the user comes in contact with the roller unit 43, the rigid rollers 432 provide a massage effect, and the soft rollers 431 provide a buffering effect to reduce pain resulting from direct contact with the rigid rollers 432.

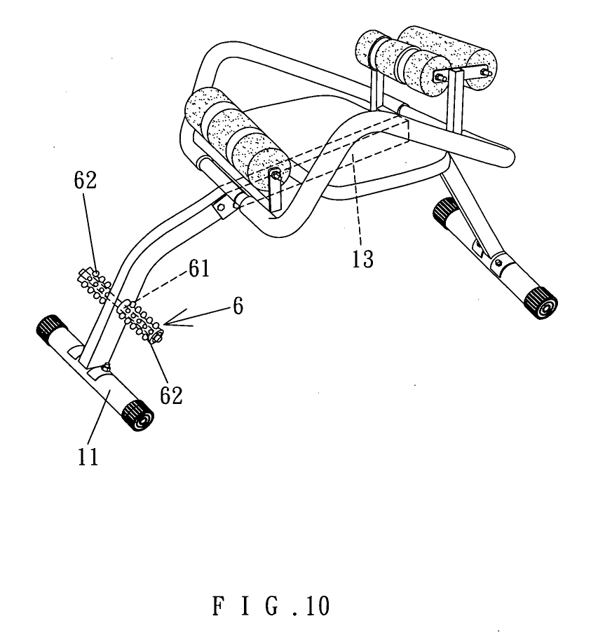

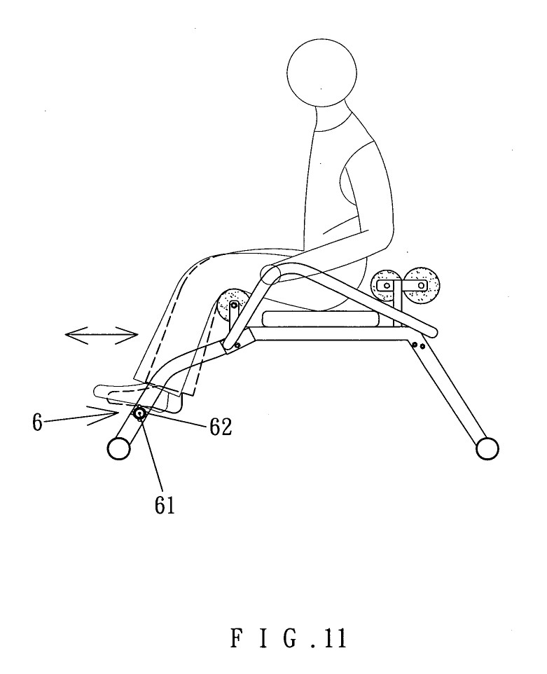

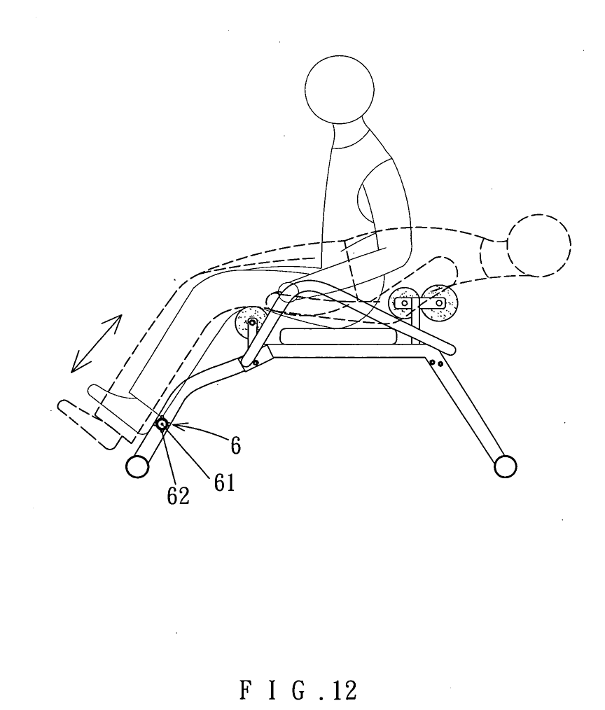

FIGS. 10-12 show a modified embodiment of the exerciser. Specifically, a massage device 6 is provided on the front leg section 11. In particular, the massage device 6 includes an axle 61 extending through the front leg section 11 and including two ends on opposite sides of the front leg section 11. Two massage wheels 62 are rotatably mounted on the ends of the axle 61. Thus, the calves or the soles of the user resting on the massage wheels 62 can be massaged when the massage wheels 62 rotate.

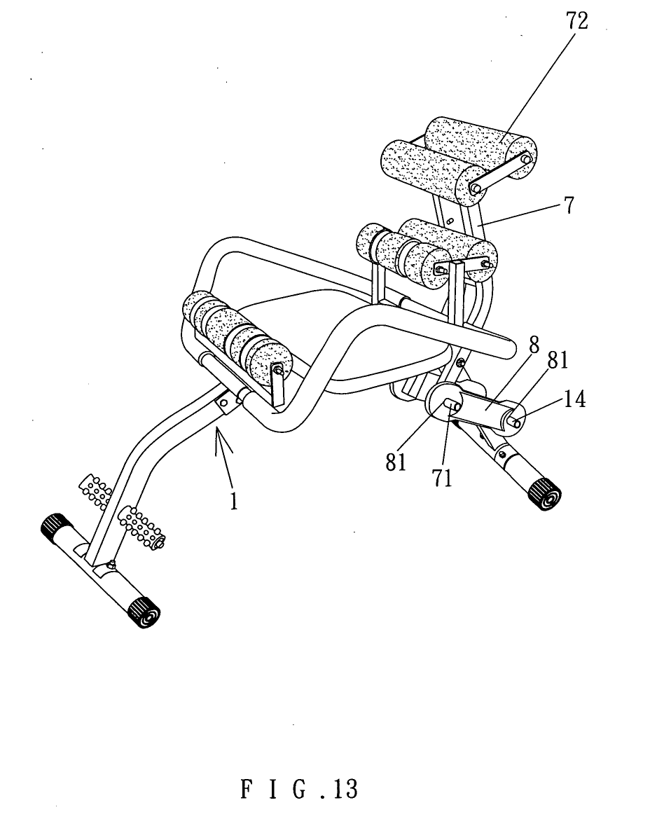

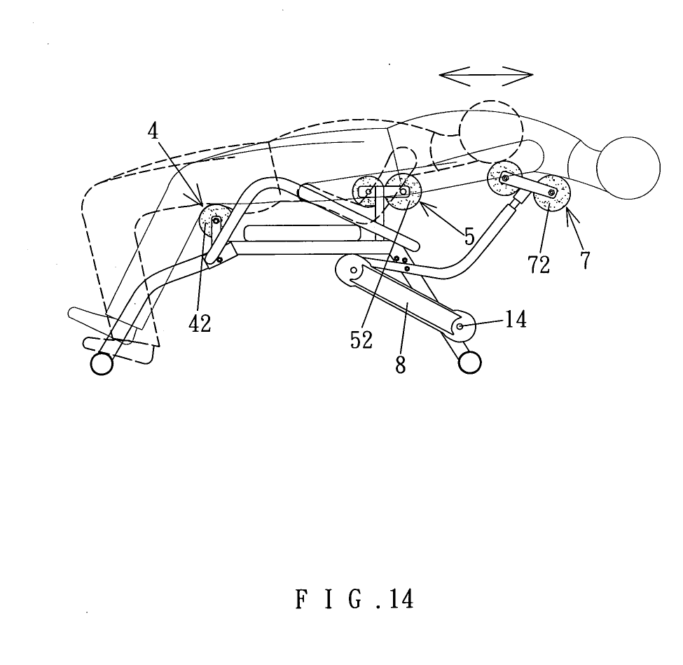

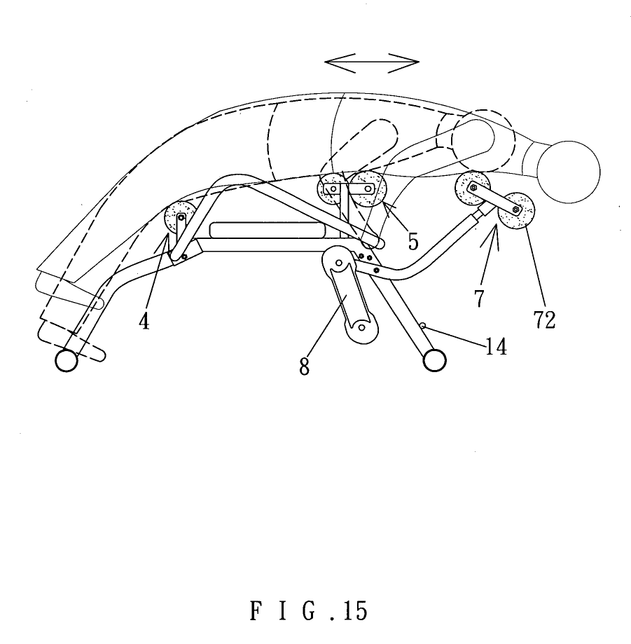

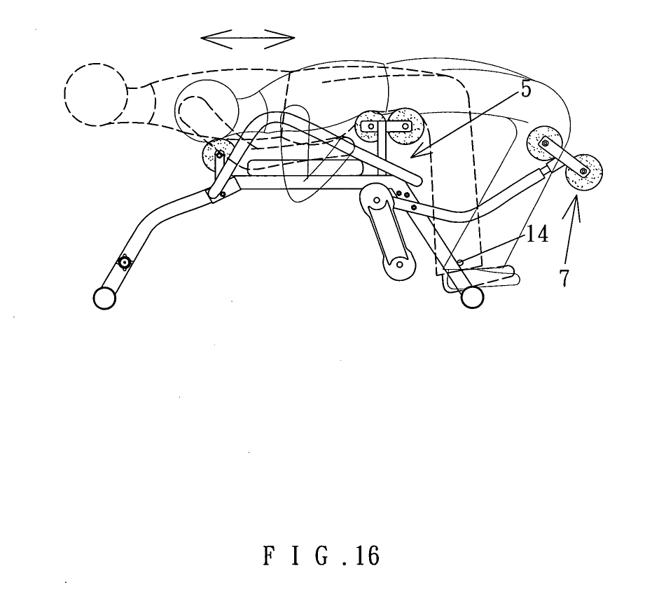

FIGS. 13-16 show another embodiment of the exerciser. Specifically, a backrest 7 and at least one elastic element 8 are mounted to the main frame 1. In the preferred embodiment shown in FIGS. 13-16, the rear leg section 12 includes two pins 14. The back frame 7 is pivotably connected to the main frame 1 and includes two pegs 71. Two elastic elements 8 are provided and each include a first end removably connected to one of the pins 14 and a second end removably connected to one of the pegs 71 for biasing an end of the back frame 7 upward and for returning the back frame 7. At least one roller 72 (two rollers in this embodiment) is rotatably mounted to the end of the back frame 7. With reference to FIG. 14, the user can lie down and moves his or her back from the rollers 52 onto the rollers 72 to obtain a different massage effect and a different exercising effect through use of the back frame 7. However, one of the first and second ends of each elastic element 8 can be removed from the pin 14 or the peg 71, allowing the end of the back frame 7 to be lowered, as shown in FIG. 15. The user can stand on the front leg section 11 facing the seat 2 and move his or her body from the rollers 52 onto the rollers 72, obtaining another massage effect and another exercising effect. When the end of the back frame 7 is lowered, the user can lie on the exerciser in a different direction, as shown in FIG. 16. When only one elastic element 8 is utilized, the rear section 12 includes only one pin 14, and the back frame 7 includes only one peg 71.

The roller supports 411 and 511 can slightly sway relative to the main frame 1. Furthermore, the main frame 1 can have other forms and shapes, not limited to the forms and shapes shown in the drawings.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. An exerciser comprising, in combination:
a main frame including a support section;
a seat mounted on top of the support section, with the seat including front and rear ends spaced in a first direction;
two handgrips mounted on opposite sides of the seat and spaced in a second direction perpendicular to the first direction;
a first roller mechanism including a first roller support mounted to the support section and at least one first roller rotatably supported by the first roller support; and
a second roller mechanism including a second roller support mounted to the support section and at least one second roller rotatably supported by the second roller support, with the seat intermediate the first and second roller supports in the first direction.

2. The exerciser as claimed in claim 1, with said at least one first roller including a plurality of soft rollers and a plurality of rigid rollers, with the plurality of rigid rollers and the plurality of soft rollers being alternately disposed.

3. The exerciser as claimed in claim 1, with the main frame further including front and rear leg sections spaced in the first direction, with the seat intermediate the front and rear leg sections in the first direction, with the exerciser further comprising, in combination: an axle extending through the front leg section and including two ends on opposite sides of the front leg section; and two massage wheels rotatably mounted on the two ends of the axle.

4. The exerciser as claimed in claim 1, with the rear leg section including at least one pin, with the exerciser further comprising, in combination: a back frame pivotably connected to the main frame, with the back frame including at least one peg; at least one elastic element including a first end removably connected to said at least one pin and a second end removably connected to said at least one peg for biasing an end of the back frame upward and for returning the back frame; and at least one third roller rotatably mounted to the end of the back frame, with one of the first and second ends of said at least one elastic element removable from one of said at least one pin and said at least one peg, allowing the end of the back frame to be lowered.
